(19) United States
(12) Patent Application Publication
(10) Pub. No.: US 2012/0084905 A1
(43) Pub. Date: Apr. 12, 2012

(54) FUNCTIONAL PROTECTIVE CLOTHING UNIT

(75) Inventors: Hasso von Blücher, Erkath (DE); Benedikt Bones, Korschenbroich (DE); Bertram Böhringer, Wuppertal (DE)

(73) Assignee: Blucher GMBH, Erkrath (DE)

(21) Appl. No.: 12/937,067

(22) PCT Filed: Apr. 8, 2009
(86) PCT No.: PCT/EP09/02612

§ 371 Date: Nov. 22, 2011

(30) Foreign Application Priority Data
Apr. 10, 2008 (DE) 10 2008 018 498.5

(51) Int. Cl. A62B 17/00; A41D 13/00; A62B 17/04

(52) U.S. Cl. 2/457; 2/69

(57) ABSTRACT

The invention relates to a functional protective clothing unit which provides protection from chemical and/or biological toxic and harmful substances, especially warfare agents, the protective clothing unit comprising a protective suit which provides protection from chemical and/or biological toxic and harmful substances, especially warfare agents, and a wrap which is associated with the protective suit and repels organic substances in liquid form. The protective suit is equipped with an adsorptive material for adsorbing organic substances and the wrap is worn on top of the protective suit to extend the protective function of the protective suit when worn and covers the protective suit at least partially and/or in some sections thereof.

### CROSS-REFERENCES TO RELATED APPLICATIONS

This application is a National Stage filing of International Application PCT/EP 2009/002612, filed Apr. 8, 2009, claiming priority to German Application No. DE 10 2008 018 498.5 filed Apr. 10, 2008, entitled “FUNCTIONAL PROTECTIVE CLOTHING UNIT.” The subject application claims priority to PCT/EP 2009/002612, and to German Application No. DE 10 2008 018 498.5, and incorporates all by reference herein, in their entirety.

### BACKGROUND OF THE INVENTION

The present invention relates to a functional protective clothing unit providing protective performance against chemical and/or biological toxics and noxiants, more particularly warfare agents, providing protective performance against chemical and/or biological toxics and noxiants, more particularly warfare agents. The protective clothing unit includes a protective suit equipped with at least one adsorption material to adsorb organic substances and provide protective performance against chemical and/or biological toxics and noxiants, more particularly warfare agents, and a wrap assigned to the protective suit and to reject organic substances in liquid form. The wrap extends the protective performance provided by the protective suit and in the donned state is disposed over the protective suit covering the protective suit at least partially and/or regionally

The present invention further relates to the use of a wrap rejecting organic substances in liquid form to extend the protective performance against chemical and/or biological toxics and noxiants, more particularly warfare agents. The wrap extends the protective performance of a protective suit that is equipped with at least one adsorption material to adsorb organic substances. When the wrap is donned over the protective suit, it provides a protective clothing unit that covers the protective suit at least partially and/or regionally.

The present invention finally relates to a wrap as such with properties rejecting organic substances in liquid form preferably in the form of a poncho. The wrap includes or consists of a textile sheet material, preferably in the form of a woven fabric and/or preferably of manufactured fibers, wherein the textile sheet material has a basis weight of 20 to 150 g/m² and/or a thickness of 0.02 to 2 mm, and wherein the wrap includes a finish preventing or at least retarding the passage of organics in liquid form.

There are a series of materials which are taken up by the skin and lead to serious physical harm (noxae). Examples include chemical or biological noxiants, more particularly warfare agents, for example the vesicatory Hd (Yellow Cross) and the nerve agent sarin. People likely to come into contact with such poisons must wear a suitable protective suit and/or be protected against these poisons by suitable protective materials.

In principle there are three types of protective suits: the air and water vapor impermeable protective suits, which are equipped with a rubber layer impervious to chemical poisons and very rapidly lead to a heat buildup; the air and water vapor permeable protective suits, which offer the highest wearing comfort; and finally protective suits equipped with a membrane which generally transmits water vapor but not the poisons mentioned.

NBC protective clothing is thus traditionally formed either from completely impermeable systems (e.g., suits of butyl rubber) or of selectively permeable systems (e.g., membrane systems) or alternatively from permeable, more particularly adsorptive filtering systems preferably based on activated carbon (e.g., activated carbon powder, activated carbon fibers, activated carbon granules, activated carbon spherules, etc.).

Protective suits against chemical warfare agents that are intended for prolonged deployment under a variety of conditions must not lead to a heat buildup for the wearer. Accordingly, it is mainly air permeable materials or alternatively at most the selectively permeable membrane systems which are used in the civil and military sector, more particularly for deployments in disaster or battle territories.

The air permeable protective suits generally possess an adsorption layer with activated carbon, which binds the chemical poisons very durably, so that even severely contaminated suits do not represent any danger to the wearer. The immense advantage of this system is that the activated carbon is accessible on the inside surface of the protective suit as well as on the outside surface, so that any poisons penetrating at damaged or otherwise nontight sites can be very rapidly adsorbed. The adsorption layer in the previously described air permeable protective suits is engineered for example such that for example on average up to about 1.0 mm size activated carbon particles are fixed to accumulations or areas of adhesive which have been printed on a carrier, and is generally complemented by a face fabric covering material and is covered on the wearer-facing inside surface by a lightweight textile material in the form of an inner liner. However, there are also occasionally composite materials comprising an activated carbon fiber sheet body, for example an activated carbon fiber nonwoven web.

Further protective suits in use are equipped with a membrane which is water vapor permeable to enhance the wearing comfort, but at the same time acts as a blocking layer against liquids and gases, more particularly toxics. Such a material is described in EP 0 827 451 A2 for example. Protective suits having a membrane which is permeable to water vapor but impermeable to poisons, more particularly contact poisons, however, have the disadvantage that poisons penetrating at non-tight locations remain inside the protective suit and are taken up by the skin of the wearer. Protective suits have accordingly been designed where the membrane and the adsorption layer are combined with each other (cf. WO 2005/049147 A1).

It is thus a characteristic feature of prior art protective suits that to ensure an improved protective performance against chemical toxics/noxiants they are often equipped with adsorbents, more particularly high-performance adsorbents. Activated carbon is often used in this respect, since activated carbon as such has outstanding properties in relation to the adsorption of toxic substances. However, the disadvantage with using adsorbents of the aforementioned kind is occasionally that they have to some extent nonspecific/nonselective adsorption characteristics, so that in addition to the actual toxics/noxiants there are a large number of other compounds/substances, such as organic compounds, which are adsorbed by the activated carbon. This can lead in the worst case scenario to a premature exhaustion of the adsorption layer, thereby occasionally impairing/reducing the protective performance of the protective suit. This applies more particularly to the case scenario whereby the protective suit/adsorption material can come into contact with large amounts of organic liquids, such as power fuels, lubricants or the like, as is the case for example with the military personnel responsible for refueling/maintaining military vehicles.

This is because it is often necessary in this connection for military personnel and soldiers under deployment conditions particularly in the deployment/battle territory to wear if necessary protective suits in order to be protected against any NBC attacks. On the other hand, military personnel responsible for refueling/maintaining military vehicles are exposed to a high risk of additional and undesired contamination of the protective suit with organic liquids, for example power fuels and/or lubricants, since military vehicles often have to be refueled quickly and under occasionally adverse conditions of deployment. It can happen in such situations that—for example when power fuel is spilt or on refueling splashes back out of a tank opening or the like—even relatively large amounts of organic liquids will come into contact with/directly land on the protective suit and there lead to a rapid/premature saturation of the adsorptive components, so that the protective performance to be provided by the protective suit against toxics and warfare agents is no longer fully ensured.

To avoid the aforementioned issues there are not efficacious prior art measures/devices that lead to an effective lengthening of the protective performance of protective suits under high contamination risk with organic liquids, such as power fuels, lubricants or the like, and that are efficiently handlable and practical under deployment conditions.

### BRIEF SUMMARY OF THE INVENTION

The present invention therefore has for its object to provide a functional protective clothing unit whereby the prior art disadvantages described above are at least partly avoided/ameliorated. More particularly, the functional protective clothing unit should lead to a lengthening of the protective performance of a protective suit assigned to the functional protective clothing unit.

The present invention further has for its object to use/provide a specific wrap to lengthen the protective performance of a protective suit as part of a protective clothing unit, wherein the wrap shall in the deployment scenario be rapidly and conveniently donned over the protective suit and the wrap as such shall altogether not impair the wearing comfort significantly, if at all. The wrap as a constituent of a functional protective clothing unit shall be easily packable with small pack dimensions, so that the wrap shall be convenient to carry along even away from deployment.

We have found that this object is achieved as proposed by a functional protective clothing unit providing protective performance against chemical and/or biological toxics and noxiants, more particularly warfare agents providing protective performance against chemical and/or biological toxics and noxiants, more particularly warfare agents. The protective clothing unit includes a protective suit equipped with at least one adsorption material to adsorb organic substances and provide protective performance against chemical and/or biological toxics and noxiants, more particularly warfare agents, and a wrap assigned to the protective suit and to reject organic substances in liquid form. The wrap extends the protective performance provided by the protective suit and in the donned state is disposed over the protective suit covering the protective suit at least partially and/or regionally.

We have found that this object is further achieved by the use of a wrap rejecting organic substances in liquid form to extend the protective performance against chemical and/or biological toxics and noxiants, more particularly warfare agents, of a protective suit equipped with at least one adsorption material to adsorb organic substances wherein the wrap extends the protective performance of a protective suit that is equipped with at least one adsorption material to adsorb organic substances. When the wrap is donned over the protective suit, it provides a protective clothing unit that covers the protective suit at least partially and/or regionally. Further, advantageous developments and embodiments are described.

The object underlying the present invention is finally achieved by a wrap with properties rejecting organic substances in liquid form preferably in the form of a poncho. The wrap includes or consists of a textile sheet material, preferably in the form of a woven fabric and/or preferably of manufactured fibers, wherein the textile sheet material has a basis weight of 20 to 150 g/m² and/or a thickness of 0.02 to 2 mm, and wherein the wrap includes a finish preventing or at least retarding the passage of organics in liquid form. Further, advantageous developments and embodiments are described.

It will be immediately understood that embodiments, modes of execution, advantages and the like, which are recited hereinbelow in relation to one aspect of the invention only to avoid repetition, shall self-evidently also apply mutatis mutandis in respect of the other aspects of the invention.

### BRIEF DESCRIPTION OF THE DRAWINGS

FIG. 1 provides a schematic view of the inventive protective clothing unit with a wrap and a protective suit underneath, in the donned state,

FIG. 2 provides a schematic view of the inventive protective clothing unit with a wrap and a protective suit underneath, in the donned state, wherein the inventive protective clothing unit additionally includes further elements in the form of overgloves,

FIG. 3 provides a schematic view of an inventive protective clothing unit with a wrap and a protective suit underneath, in the donned state, wherein the inventive protective clothing unit includes further elements in the form of overshoes.

### DETAILED DESCRIPTION OF THE INVENTION

The present invention accordingly provides—in accordance with a first aspect of the present invention—a functional protective clothing unit providing protective performance against chemical and/or biological toxics and noxiants, more particularly warfare agents, wherein the protective clothing unit includes a protective suit equipped with at least one adsorption material to adsorb organic substances and providing protective performance against chemical and/or biological toxics and noxiants, more particularly warfare agents, and a wrap assigned to the protective suit and rejecting organic substances in liquid form, wherein to extend the protective performance provided by the protective suit the wrap in the donned state is disposed over the protective suit and covers the protective suit at least partially and/or regionally.

It is thus a fundamental idea of the present invention to provide a protective clothing unit which includes, first, a protective suit comprising an adsorption material and having outstanding protective properties against chemical and/or biological toxics and noxiants, such as sarin, Hd and the like, and, secondly, a wrap which can be donned/worn specifically over the protective suit—for example when military personnel/soldiers in action handle/work with liquid organic substances, such as power fuels or the like—in order that any unnecessary contamination of the protective suit as such with organic liquids may be thereby avoided. This ensures in the context of the present invention that the protective suit altogether provides an extended and hence enhanced protective performance against chemical toxics and noxiants, since premature saturation of the adsorption material is prevented. Moreover, the wrap has protective potential against toxic gases and dangerous, more particularly inorganic liquids, such as acids (battery acid for example) and/or alkalis, especially in the case of a gas or air impermeable design.

The concept according to the present invention is accordingly to provide a protective clothing unit having two components—a protective suit as one component and a wrap as the other—wherein the wrap can as necessary be donned to prevent the contamination of the protective suit, particularly with organic liquids of the aforementioned kind, to at least partially cover the protective suit. As a component of the protective clothing unit according to the present invention, the wrap—as will be further detailed hereinbelow—combines its very good properties in respect of the rejection of organic substances in liquid form with outstanding properties in respect of breathability, basis weight, packability, breaking strength and the like, so that the wrap as such not only does not significantly impair the wearing comfort of the protective clothing unit but also can be efficiently stowed and hence readily carried on the person. The wrap is accordingly easy to take off the protective suit.

The “organic substances in liquid form” referred to in the context of the present invention in respect of the properties of the wrap of the functional protective clothing unit of the present invention which are rejecting in this regard are more particularly organic compounds, more particularly organic hydrocarbons, that are liquid at room temperature (T≈20° C.) and ambient pressure (about 1013 hPa). They may comprise more particularly petrochemical products, such as power fuels, for example gasoline, diesel, kerosene or the like, but also lubricants, such as engine oils, or the like. Such organic substances in liquid form can also be referred to collectively as liquid POLs (petroleum, oil and lubricants).

It is accordingly envisioned in the context of the present invention that in the event of the possible risk of direct exposure to or contamination with organic substances in liquid form, more particularly as defined above, the wrap/oversuit is donned and worn on top of the protective suit in order that the properties of the wrap which reject organic substances in liquid form may prevent any contamination of the protective suit even in the event of direct contact with the substances, since these are already kept away by the wrap.

In this respect, it is a particular advantage in the context of the present invention for the wrap in the donned state to cover at least the trunk/upper body of a wearer, a soldier for example. In general, it should be ensured in the context of the present invention at a minimum that that side of the body of a wearer which faces toward the source of the organic substance in liquid form is covered with the wrap, so that accordingly the protective suit underneath the wrap is also covered by the wrap.

The wrap part of the protective clothing unit of the present invention should as such include a head opening. In addition, the wrap should include arm openings and/or leg openings. This ensures that the wrap when it is to be used can be quickly and straightforwardly thrown on/pulled over the protective suit, more particularly that the arms can be used for further manual activities.

In one embodiment, the wrap can be formed as a poncho, in which case a poncho is to be understood at its simplest as an at least essentially rectangular form of the wrap—based on the spread-out state of the wrap or based on the outline area of the wrap—with a head opening in the middle, through which the head can be pushed. In its donned state, then, the wrap rests like a coat on the shoulders of the wearer, while at the same time at least the trunk and optionally also the back part of the wearer or to be more precise the corresponding sections of the protective suit are covered by the wrap, with the arms of the wearer poking out sideways from the wrap or else if necessary also remaining hidden under the poncho/wrap.

It can further be envisioned according to the present invention for the wrap to include arm elements and/or leg elements. In this way, the arms and legs, respectively, of a wearer or to be more precise the corresponding sections of the protective suit of the protective clothing unit of the present invention can also be specifically covered and thereby protected from any contamination with organic substances in liquid form. The arm elements/oversleeves and/or the leg elements/pant legs may have been attached to the corresponding arm openings and leg openings in the wrap of the protective clothing unit according to the present invention.

It can further be envisioned for the wrap to include a collar and/or for the wrap to include a hood. When the wrap of the protective clothing unit of the present invention includes a hood, this hood may be equipped with receiving and/or connecting elements for an NBC protective mask. The use-directed equipping of the wrap with a collar makes it possible to extend the protective performance of the wrap to the neck region of a wearer or to be more precise to the corresponding neck section of the protective suit. Equipping the wrap with a hood has the effect of also protecting the head or a wrap-covered hood of the protective suit of the protective clothing unit of the present invention. The specific embodification of the hood with receiving/connecting elements for an NBC protective mask allows the protective clothing unit of the present invention as such also to be used as part of a comprehensive protection system for the entire body of a wearer or the entire protective suit of the protective clothing unit of the present invention. Connecting the hood of the wrap to the NBC protective mask, which often has to be worn in military deployment or when handling organic substances of the aforementioned kind, also prevents/minimizes the breakthrough of organic substances in liquid form in the region of the contact face between the hood on the one side and the NBC protective mask on the other.

The wrap of the protective clothing unit of the present invention can be present in a multiplicity of shapes/forms. Thus, the wrap may be formed as a cape, as a cloak, as a poncho, as an apron, as a cowl, as a vest, as a jacket, as a coat or the like. A person having ordinary skill in the art is always able to adapt/optimize the specific form/cut of the wrap against the background of the specific intended use in particular. As mentioned above, however, it is preferable according to the present invention for the wrap to be present in the form of a poncho.

In a further embodiment according to the present invention, the wrap includes or consists of, preferably consists of, a textile sheet material, more particularly wherein the textile sheet material is formed as a woven, knitted, laid or bonded fabric, more particularly as a fibrous nonwoven web, but preferably as a woven fabric. This is because particularly the construction of the textile sheet material in the wrap as a woven fabric leads to a high stability as associated with an excellent breaking strength. In this connection, it is particularly advantageous according to the present invention when the woven fabric is formed as a ripstop, twill or plain construction. The aforementioned constructions for woven textile sheet materials are known as such to those skilled in the art, and so no further observations are needed in this regard. It is similarly possible in the context of the present invention for variations and modifications of the aforementioned constructions to be realized in respect of the textile sheet material of the wrap. A particularly close weave moreover improves the blocking properties with regard to organic as well as inorganic substances in liquid form.

In an embodiment which is particularly preferred according to the present invention, the wrap and/or the sheet material comprises or consists of, preferably consists of, manufactured fibers and/or yarns, preferably synthetic fibers and/or yarns, more particularly selected from the group consisting of polyesters (PES), polyolefins, more particularly polyethylene (PE) and/or polypropylene (PP), polyvinyl chloride (CLF), polyvinylidene chloride (CLF), acetate (CA), triacetate (CTA), acrylic (PAN), polyamide (PA), more particularly aromatic, preferably flame-retardant polyamides, fluoropolymers, more particularly polytetrafluoroethylene (PTFE), polyvinyl alcohol (PVAL), polyurethanes, polyvinyl esters, (meth)acrylates, and mixtures thereof, preferably polyamide (PA) and/or polyester (PES).

The flame-retardant polyamides may comprise NOMEX® for example. The aforementioned codes for textile fibers come from DIN 60001-4 (August 1991). For further details concerning the fibers reference may also be made to the recitations concerning the notion of textile fibers—interchangeably also referred to as textile fiber materials—as per Römpp Chemielexikon, Georg Thieme Verlag, Stuttgart/New York, volume 6, 1999, pages 4477 to 4479, headword: “Textilfasern”, the entire disclosure content of which including the references cited therein is hereby incorporated by reference.

The specific use of manufactured fibers results in high chemical resistance for the resulting wrap component of the protective clothing unit of the present invention, so that the material as such has high resistance in respect of organic substances in liquid form. Moreover, the specific use of manufactured/synthetic fibers makes it possible to achieve low basis weights and thicknesses for the resulting wrap, while at the same time breaking strength is high.

In principle, use of natural fibers or yarns, for example of cotton and/or linen, is also possible in respect of the sheet material (although this is less preferable according to the present invention). Another possible option is the conjoint use of manufactured fibers/yarns and natural fibers/yarns for the sheet material.

Moreover, the textile sheet material of the wrap component of the protective clothing unit of the present invention has a good fabric hand and does not rustle a lot, which is very important in military deployment in particular.

The wrap component of the protective clothing unit of the present invention has a low basis weight. Thus, the wrap and/or the textile sheet material should have a basis weight of 20 to 150 g/m², more particularly 25 to 125 g/m², preferably 30 to 100 g/m² and more preferably 40 to 70 g/m².

Similarly, the thickness of the wrap or of the textile sheet material is very low. In this context, the wrap and/or the textile sheet material should have a thickness of 0.02 to 2 mm, more particularly 0.04 to 1 mm, preferably 0.06 to 0.5 mm, more preferably 0.08 to 0.25 mm and even more preferably 0.09 to 0.12 mm.

The low basis weight and the low thickness of the wrap component of the protective clothing unit of the present invention, or of the textile sheet material used for the wrap, result firstly in an excellent wearing comfort, since the wrap as such is lightweight and not very rigid. The low basis weight and the low thickness also lead to an improved fabric hand on the part of the wrap component of the protective clothing unit of the present invention, and rustling is also further minimized. Further still, the low basis weight and the low thickness result in very good foldability/packability on the part of the wrap.

As mentioned, the wrap used as part of the protective clothing unit of the present invention has properties preventing the passage of organics in liquid form. This can be ensured for example according to the present invention wherein the wrap component of the protective clothing unit of the present invention includes a finish which prevents or at least retards the passage of organics in liquid form.

In this connection, the wrap component of the protective clothing unit of the present invention may equally have an oleophobic and/or hydrophobic finish to ensure the rejecting properties against organic substances in liquid form in particular.

The specific finish applied to the wrap ensures in a particular manner according to the present invention that the wrap provides high protection/blocking/rejection in respect of organic substances in liquid form, more particularly as defined above. The specific finish applied to the wrap or to the textile sheet material used in relation to the wrap, particularly in the context of an oleophobicization and/or hydrophobicization, thus ensures that organic substances in liquid form are at least essentially not able to penetrate into/through the wrap, so that with the wrap in its donned state the wrap-covered protective suit component of the protective clothing unit of the present invention is efficaciously protected from these substances, since at least a large proportion of the organics in liquid form are already held back at the surface of the wrap and bead off directly from the surface of the wrap.

The specific finish, more particularly in the context of an oleophobicization or hydrophobicization, similarly ensures according to the present invention that the wrap component of the protective clothing unit of the present invention also has water-rejecting properties, so that the wrap as such also constitutes good protection against rain/wetness.

Moreover, the wrap has protective potential against toxic gases and dangerous, more particularly inorganic liquids, such as acids (battery acid for example) and/or alkalis, more particularly in the case of a gas or air impermeable design.

The wrap component of the protective clothing unit of the present invention should be provided with the finish at least on that side which in the donned state faces the organics or inorganics in liquid form—that is to say wearer of the protective clothing unit of the present invention on that side which in the donned state faces away from the protective suit. According to the present invention, the wrap may thus be provided with the finish at least on that side which faces away from the protective suit. Protective performance can be still further enhanced in this way.

The substances useful for the more particularly oleophobic and/or hydrophobic finish and appropriate processes for conferring the finish on the wrap or on the textile sheet material of the wrap are well known as such to a person skilled in the art.

In a possible embodiment of the present invention, for example, the oleophobic and/or hydrophobic finish is present in the form of an impregnation or coating, more particularly by means of at least one fluorocarbon and/or at least one hydrofluorocarbon, more particularly at least one fluorinated polymer/fluoropolymer. For example, derivatives of perfluorinated alkanesulfonic acids can be used here. Similarly, polytetrafluoroethylene (PTFE) can also be used. Moreover, the use of more particularly fluorinated silicones is also possible, although this is less preferable according to the present invention.

In an alternative embodiment of the present invention, the more particularly oleophobic and/or hydrophobic finishing of the wrap or textile sheet material can be effected by means of a plasma treatment.

In this connection, the plasma treatment can be carried out directly on the surface(s) of the wrap. The plasma treatment can also be carried out indirectly on the surface(s) of the wrap, more particularly after application of a preferably polymeric or polymerizable film onto the surface(s) to be treated, which is crosslinked and/or cured by the plasma treatment. In this regard, more particularly silicones, more particularly silicone oils, or organopolysiloxanes can be used as polymeric or polymerizable film.

With regard to a useful plasma treatment in the present invention for the wrap or textile sheet material, reference may be made to the applicant company's own German patent application DE 103 56 776 A1 and also to the same patent family member patent applications WO 2005/053838 A1 and US 2007/0134483 A1, the entire disclosure content of which is hereby fully incorporated by reference.

It is particularly preferable according to the present invention when the wrap component of the protective clothing unit of the present invention is gas permeable, more particularly air permeable. In this connection, the gas or air transmission rate of the wrap should be 10 to 200 1·m⁻²·s⁻¹, more particularly at least 20 1·m⁻²·s⁻¹, preferably at least 40 1·m⁻²·s⁻¹, more preferably at least 60 1·m⁻²·s⁻¹, and/or up to 1000 1·m⁻²·s⁻¹ at a flow resistance of 127 Pa. This makes it possible to further improve the wearing comfort afforded by the protective clothing unit of the present invention, more particularly in combination with a gas permeable, more particularly air permeable protective suit, since for example perspiration and/or water vapor can be efficaciously transported away from the body of the wearer.

However, it is similarly possible according to the present invention for the wrap as such to be given an air impermeable construction in order that, for example, a protective performance against gaseous chemical toxics/warfare agents which is ensured by the wrap may also be provided/further improved. In this alternative embodiment, accordingly, the wrap as such may be gas impermeable, more particularly air impermeable. The gas impermeable, more particularly air impermeable design of the wrap according to the invention has the effect of further improving the protective performance of the wrap in respect of the protective suit which in the donned state of the wrap is worn underneath, so that in this way the protective suit as such and hence the protective clothing unit of the present invention as a whole provides an even more prolonged and hence even further improved protective performance against chemical toxics and noxiants. The gas impermeable, more particularly air impermeable design of the wrap is a possibility more particularly in the case of a particularly high risk of contamination with organic substances in liquid form, as previously defined. Moreover, a wrap designed according to this embodiment to be gas impermeable, more particularly air impermeable, offers a high protective potential against toxic gases and dangerous, more particularly inorganic liquids, such as acids (battery acid for example) and/or alkalis.

It is also possible in the context of the present invention for the degree of gas permeability, more particularly air permeability, to be adjusted individually. Accordingly, the present invention makes it possible in respect of the wrap to realize a multiplicity of gradations between a high gas permeability, more particularly air permeability on the part of the wrap and an at least essentially complete gas impermeability, more particularly air impermeability. A high gas permeability, more particularly air permeability, can be envisioned for example to ensure particularly good wearing comfort in the event of deployment of the protective clothing unit of the present invention under strong physical exertion, whereas a gas impermeable, more particularly air impermeable design should be chosen for the wrap, as mentioned above, when the risk of contamination with the substances described above in this connection is particularly high (for example in the event of direct working on a power fuel installation or the like). The wrap can thus be custom tailored with regard to its degree of gas or air permeability against the background of the specific deployment/performance specification profile.

This degree of gas permeability or air permeability up to the point of gas/air impermeability can be adjusted/predetermined via the oleophobic and/or hydrophobic finish applied to the wrap, more particularly via the choice of the amount of finish used, in which case the above-described fluorocarbons or hydro fluorocarbons, such as PTFE, can be used for example in this respect.

In a possible embodiment of the present invention, relating to the arrangement of the wrap on the protective suit, the wrap in the donned state lies loose and/or unconnectedly on the protective suit. This can be accomplished for example by simply pulling or putting on the wrap over the protective suit.

In a similarly possible embodiment of the present invention, the wrap in the donned state is more particularly sectionally connectable to the protective suit. In this connection, the connection can be effected by means of for example hook and loop fasteners, zip fasteners, press studs, buttons, straps, buckles, ribbons, rubber bands or the like.

It is ensured in the context of the present invention that the wrap is easy to separate/take off from the protective suit, so that the wrap as such can for example be easily contaminated or disposed of separately, i.e., separately from the protective suit, leading to a significant cost saving. The easy separability of the wrap from the protective suit also makes it possible to stock keep the wrap separately from the protective suit and/or for the wrap to be carried along more particularly in packaged form in or on the protective suit.

In a possible embodiment of the present invention, accordingly, the wrap is foldable particularly for stocking and/or storage and/or transportation purposes, more particularly wherein the wrap is introducible into a package. Owing to the low thickness and the low basis weight, the result is, as mentioned above, a small package with low packing volume in respect of the wrap, which can be folded down to “cigarette pack format” so to speak. In this connection, the folded wrap itself can be inserted into a packaging item, in which case the wrap thus packaged can be carried along by the military personnel/soldier even when away from its deployment, and is quickly to hand.

In an embodiment of the present invention, the wrap is attachable, accommodatable and/or securable to or in the protective suit more particularly in the folded state and/or in a packaged form more particularly for stocking and/or storage and/or transportation purposes. As mentioned above, therefore, the wrap can be carried along away from its deployment on the person without major inconvenience and is additionally quickly to hand when needed, since it can be stowed in or on the protective suit itself.

The wrap as such is also printable/dyeable, so that it can be finished in camouflage colors for example.

The protective suit used in the context of the protective clothing unit of the present invention may comprise for example a protective suit known as such from the prior art, as described for example in the applicant company's own German patent DE 103 34 667 B4 and also in the same patent family member U.S. Pat. No. 7,047,568 B2, the entire disclosure content of the aforementioned printed publications being hereby incorporated in full by reference. In addition, reference with regard to the protective suit component of the protective clothing unit of the present invention may be made to the applicant company's own German patent application DE 103 54 623 A1 and also the same patent family patent applications WO 2005/049147 A1 and US 2007/0059504 A1, the entire disclosure content of which is hereby incorporated in full by reference. Finally, reference in respect of the protective suit component of the protective clothing unit of the present invention may also be made to the applicant company's own German patent application DE 10 2006 021 905 A1 and also to the same patent family patent application US 2007/0240576 A1, the entire disclosure content of which is hereby fully incorporated by reference.

The protective suit which according to the present invention can be used in the context of the protective clothing unit according to the invention can be one pieced, more particularly in the form of an overall, or multipieced, more particularly two pieced, preferably in the form of a jacket or a pant. In the two or more piece design of the protective suit, the respective constituents/elements, for example a jacket and a pant, can be designed to be connectable via specific connecting means for example. Similarly, the protective suit may include a hood and/or gloves and/or shoe/boot elements.

The adsorption material of the protective suit used in the context of the protective clothing unit of the present invention may be activated carbon, in an embodiment which is particularly preferred according to the present invention. The protective suit may include an adsorption layer with the noxiant-adsorbing adsorption material, more particularly in the form of activated carbon.

In this connection, the adsorption layer may be discontinuous. In an alternative embodiment, the adsorption layer may also be formed as an adsorption sheet filter. This ensures that any noxiants, more particularly chemical toxics/warfare agents, penetrating into the protective suit are unable to come into contact with the wearer, since they can be adsorbed by the adsorption material, more particularly the activated carbon, of the adsorption layer and thereby rendered harmless.

The adsorption material can be secured to a carrier layer, more particularly to a textile carrier layer. In this connection, the adsorption material can be disposed on that side which in the donned state faces away from the wearer and/or the wearer side facing in the direction of the wrap. Accordingly, the adsorption material is preferably, according to the present invention, fixed in relation to the optional carrier layer on that side of the carrier layer which faces toward the noxiant source.

The adsorption material here may be fixed to the carrier layer by means of an adhesive for example.

In an embodiment according to the present invention, the adsorption material of the adsorption layer may be a material based on activated carbon in the form of activated carbon particles and/or activated carbon fibers.

In this connection, the adsorption layer by way of adsorption material may thus comprise discrete activated carbon particles, preferably in granule form (“granulocarbon”) or sphere form (“spherocarbon”). In this connection, the average diameter of the activated carbon particles should be less than 1.0 mm, preferably less than 0.8 mm and more preferably less than 0.6 mm. Moreover, the activated carbon particles should be present in the adsorption layer in an amount of 5 to 500 g/m², more particularly 10 to 400 g/m², preferably 20 to 300 g/m² and more preferably 25 to 250 g/m².

Granulocarbon, more particularly spherocarbon, has the decisive advantage of being attrition resistant and very hard, which is very important in respect of durability. Preferably, the bursting pressure of an individual activated carbon particle, more particularly activated carbon granule/spherule, is generally at least about 5 N, more particularly at least about 10 N, and can go as high as about 20 N.

In an alternative embodiment, the adsorption layer by way of adsorption material may comprise activated carbon fibers, more particularly in the form of an activated carbon sheet body, more particularly wherein the activated carbon sheet body has a basis weight of 20 to 200 g/m² and more particularly 50 to 150 g/m², and/or more particularly wherein the activated carbon sheet body is a woven, loop-formingly knitted, laid or bonded activated carbon fabric, more particularly based on carbonized and activated cellulose and/or a carbonized and activated acrylonitrile.

It is similarly possible for the adsorption material of the adsorption layer to combine activated carbon particles and activated carbon fibers. In this connection, activated carbon particles have the advantage of a higher adsorption capacity, while activated carbon fibers have superior adsorption kinetics.

The adsorption material used according to the present invention, more particularly the activated carbon, should have an internal surface area (BET) of at least 800 m²/g, more particularly of at least 900 m²/g, preferably of at least 1000 m²/g and more preferably in the range from 800 to 2500 m²/g.

To increase the adsorption efficiency/performance, the adsorption material of the adsorption layer, more particularly the activated carbon particles/fibers, may also be impregnated with at least one catalyst. Catalysts useful according to the present invention include for example enzymes and/or metal ions, preferably copper, silver, cadmium, platinum, palladium, zinc and/or mercury ions. The amount of catalyst can vary within wide limits; generally it is in the range from 0.05% to 12% by weight, preferably in the range from 1% to 10% by weight and more preferably in the range from 2% to 8% by weight, based on the weight of the adsorption material.

The protective suit used in the context of the protective clothing unit of the present invention may have a multilayered construction, in which case the individual layers can be bonded together by means of an adhesive known per se to a person skilled in the art, in which case the adhesive is applied in respect of the individual layers in spot form or dot grid form for example.

In this connection, the layered construction may comprise an outer layer, which in the donned state faces away from the wearer and/or toward the wrap, and an inner layer, assigned to the outer layer and in the donned state facing toward the wearer and/or away from the wrap. Between the outer layer and the inner layer there may be disposed the adsorption layer with the noxiant-adsorbing adsorption material, more particularly activated carbon, more particularly as defined above.

In a further embodiment according to the present invention the protective suit component of the protective clothing unit of the present invention additionally includes at least one membrane. The membrane may be water impermeable and/or air impermeable and preferably be at least essentially impermeable to toxics, such as chemical or biological toxics/warfare agents, or at least retard their passage. Owing to these specific properties and owing to the preferred arrangement of the membrane between an outer layer and the adsorption layer of the protective suit, the invention ensures that any noxiants penetrating through the outer layer of the protective suit or previously through the wrap are held back by the membrane, so that the noxiants/toxics as a result reach the adsorption materials only in very small amounts, if at all. When a membrane is used, it can be envisioned according to the present invention for the membrane to be breathable, more particularly water vapor permeable, in order that the wearing comfort of the protective clothing unit of the present invention may be ensured/enhanced.

As mentioned above, the membrane may be disposed between the outer layer of the protective suit and the adsorption layer and/or between the inner layer and the adsorption layer, preferably between the outer layer and the adsorption layer, and/or wherein the membrane is at least essentially impermeable to chemical and/or biological toxics and noxiants, more particularly warfare agents, or at least retards their passage.

In addition to the above-described wrap component of the functional protective clothing unit of the present invention, the protective suit component as such may also be gas permeable, more particularly air permeable, so that altogether the result is a gas permeable, more particularly air permeable, protective clothing unit according to the invention which provides a high wearing comfort as well as a high and prolonged protective performance against chemical toxics/noxiants.

It can finally be envisioned according to the invention for the protective clothing unit according to the invention to include at least one additional wrap in the form of leggings, gaiters and/or overboots and/or in the form of oversleeves and/or overgloves, in order to ensure a prolongation of the protective performance/properties of shoes/(military) boots having adsorptive components. The additional wrap may correspond in its construction/the materials used for it to the wrap described above.

The present invention further provides—in accordance with a second aspect of the present invention—the use of a wrap rejecting organic substances in liquid form to extend the protective performance against chemical and/or biological toxics and noxiants, more particularly warfare agents, of a protective suit equipped with at least one adsorption material to adsorb organic substances, wherein the wrap is donned over the protective suit to obtain a protective clothing unit wherein the wrap covers the protective suit at least partially and/or regionally.

The use which the present invention provides in respect of the wrap described above thus has the purpose of preventing premature exhaustion of the adsorption material of the protective suit and/or any unwanted contamination of the protective suit with attendant saturation of the adsorption material.

The present invention finally provides—in accordance with a third aspect of the present invention—a wrap as such with properties rejecting organic substances in liquid form, preferably in the form of a poncho, wherein the wrap includes or consists of a textile sheet material, preferably in the form of a woven fabric and/or preferably of manufactured fibers, wherein the wrap or the textile sheet material has a basis weight of 20 to 150 g/m² and/or a thickness of 0.02 to 2 mm, and wherein the wrap includes a finish preventing or at least retarding the passage of organics in liquid form.

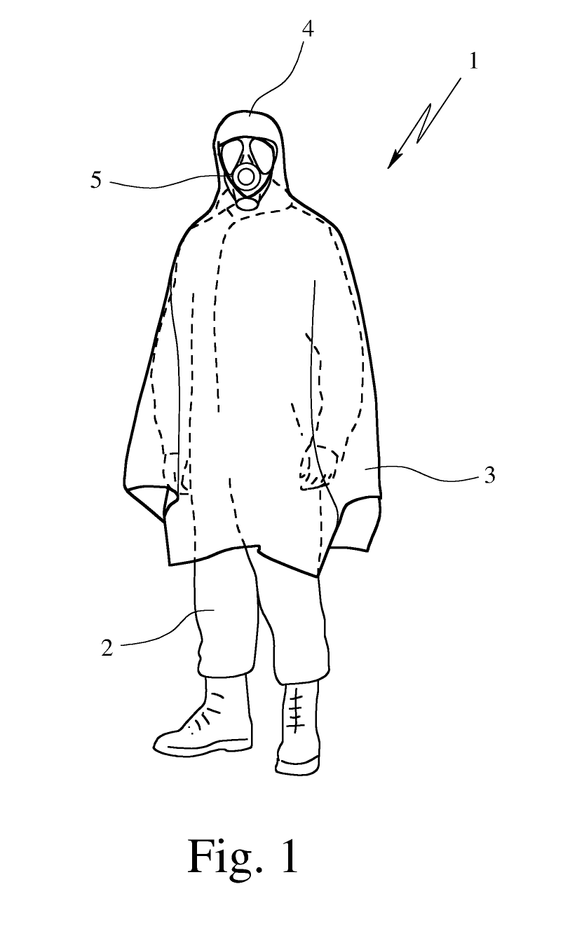

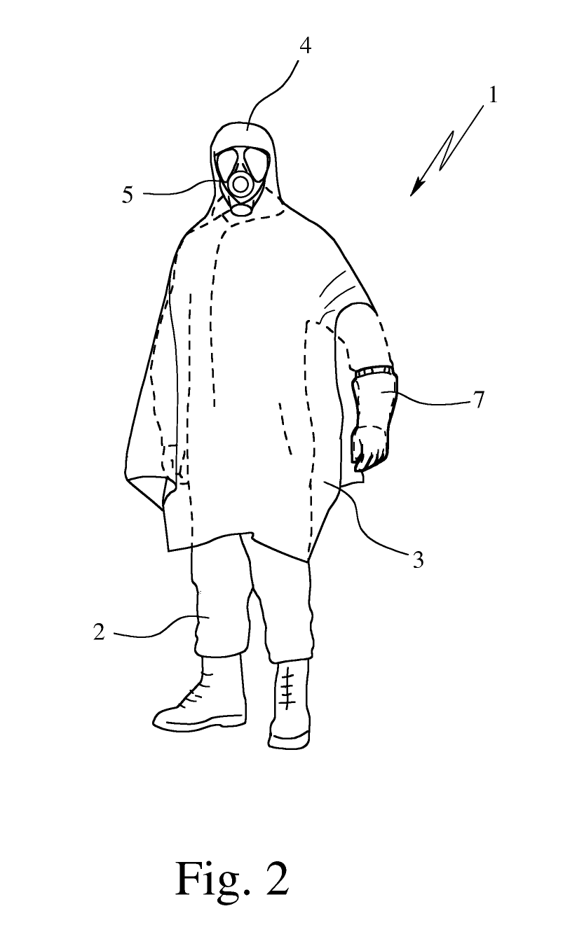

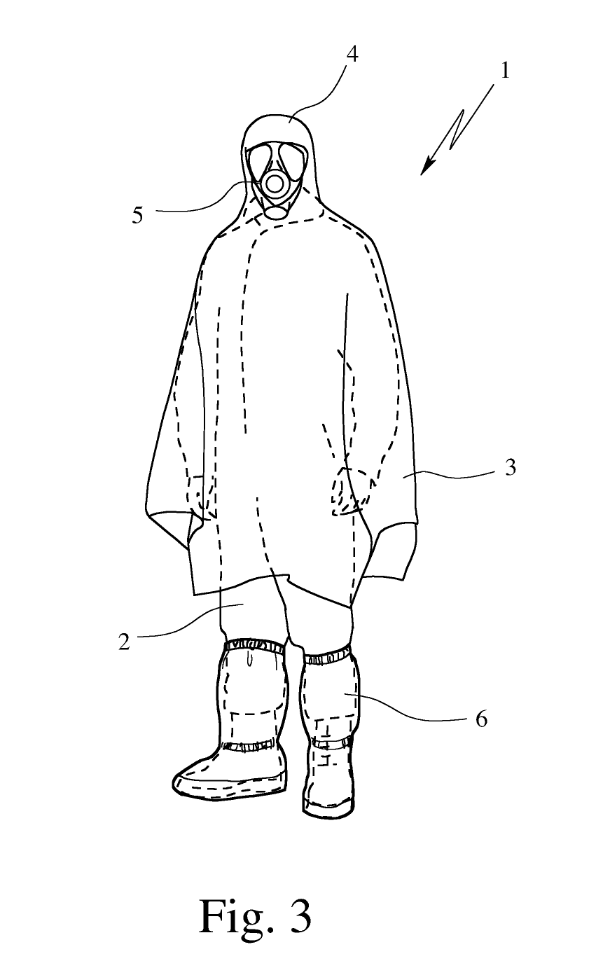

Further advantages, properties and features of the present invention will become apparent from the following description of preferred illustrative embodiments shown in the figures, where:
FIG. 1 shows a schematic view of the inventive protective clothing unit with a wrap and a protective suit underneath, in the donned state,
FIG. 2 shows a schematic view of the inventive protective clothing unit with a wrap and a protective suit underneath, in the donned state, wherein the inventive protective clothing unit additionally includes further elements in the form of overgloves,
FIG. 3 shows a schematic view of an inventive protective clothing unit with a wrap and a protective suit underneath, in the donned state, wherein the inventive protective clothing unit includes further elements in the form of overshoes.

FIGS. 1 to 3 show an inventive functional protective clothing unit 1 providing protective performance against chemical and/or biological toxics and noxiants, more particularly warfare agents, wherein the protective clothing unit 1 includes a protective suit 2 equipped with at least one adsorption material to adsorb organic substances and providing protective performance against chemical and/or biological toxics and noxiants, more particularly warfare agents, and a wrap 3 assigned to the protective suit 2 and rejecting organic substances in liquid form, wherein to extend the protective performance provided by the protective suit 2 the wrap 3 in the donned state is disposed over the protective suit 2 and covers the protective suit 2 at least partially and/or regionally. In the context of the inventive embodiments as per FIGS. 1 to 3, the wrap 3 of the inventive functional protective clothing unit 1 in the form of a poncho is equipped with a head opening, and the wrap additionally includes a hood 4 for covering a head of the wearer of the inventive functional protective clothing unit 1. The hood 4 is also connected to an NBC protective mask 5.

FIG. 2 further shows the inventive embodiment whereby the inventive functional protective clothing unit 1 includes an additional wrap in the form of oversleeves/overgloves 7 for protecting the (lower) arms/hands/the corresponding sections of the protective suit 2. The material of the oversleeves/overgloves 7 corresponds to the material of the wrap 3.

FIG. 3 finally shows an inventive embodiment whereby the inventive protective clothing unit 1 in addition to the wrap 3 and the protective suit 2 further includes a wrap in the form of overboots 6, which overboots serve to protect the feet/legs of the wearer of the inventive functional protective clothing unit 1 and/or of the corresponding sections of the protective suit 2. Again, in this embodiment, the material for the overboots 6 may correspond to that of the wrap 3 as such.

The functional protective clothing unit or rather the protective suit and the wrap may be manufactured in a conventional manner. This manner is very well known to a person skilled in the manufacture of protective clothing, so that no further observations are needed in this respect.

The present invention thus altogether provides a protective clothing unit comprising a wrap which is specifically adapted to a protective suit and which ensures even under adverse conditions and high contamination with organic liquids, such as power fuels, lubricants or the like, an effective prolongation of the adsorptive properties and hence of the protective performance of the protective suit from toxic substances, more particularly toxics/warfare agents, and which is efficiently handlable and practical even under deployment conditions and meets high requirements of military deployment, more particularly also with regard to a high wearing comfort.

Further embodiments, modifications and variations of the present invention are readily apparent to and realizable by the ordinarily skilled on reading the description without their having to go outside the realm of the present invention.

The present invention is illustrated with reference to the following illustrative embodiments which, however, shall not in any way restrict the present invention.

### Illustrative Embodiments

Three different protective clothing systems are investigated, viz.:
1) a permeable commercially available NBC protective suit providing protection against chemical and/or biological toxics and noxiants based on an activated carbon layer with additional outer and inner layer (comparison),
2) an inventive functional protective clothing unit including the same protective suit as 1), but additionally equipped with a wrap assigned to the protective suit and disposed on/covering the protective suit, rejecting organic substances in liquid form and based on a woven fabric of synthetic fibers (woven polyamide fabric, basis weight: 42 g/m²) (Inventive Example 1),
3) an inventive functional protective clothing unit like 2), except that the wrap is additionally oleophobicized and hydrophobicized with a fluoropolymer impregnation (Inventive Example 2).

The protective performance against organics in liquid form is tested using a standardized dual flow test. To this end, the test materials (sample area: 10 cm² each) are stretched in a test cell over a PE membrane (10 μm), which simulates the human skin, and the substance to be tested (here: jet fuel, CS₂ or mustard gas) is applied in liquid form to the surface of the particular test material using a canula and allowed to soak in and an air stream is applied above and below the test material. The cumulative breakthrough values are determined by means of gas chromatography (relative humidity 80%, temperature 30° C., 250 ml/min air stream over the test material and 300 ml/min air stream under the test material, 24 h duration). This test simulates the diffusion and penetration of noxiants through the test material and in effect simulates the flat contact area of the protective clothing on the skin, the latter being simulated by the PE membrane.

The results are reproduced in the tables which follow:

TABLE 1
jet fuel

| | Penetration | Penetration | Penetration |
|---|---|---|---|
| | 0-6 h | 6-24 h | 0-24 h |
| | (μg/cm²) | (mg · min/m³) | (mg · min/m³) |
| Comparison | 9.9 | 14.4 | 24.3 |
| Inv. Ex. 1 | 1.0 | 1.9 | 2.9 |
| Inv. Ex. 1 | 0.3 | 0.1 | 0.4 |

TABLE 2
CS₂

| | Penetration | Penetration | Penetration |
|---|---|---|---|
| | 0-6 h | 6-24 h | 0-24 h |
| | (μg/cm²) | (mg · min/m³) | (mg · min/m³) |
| Comparison | 10.4 | 8.5 | 18.9 |
| Inv. Ex. 1 | <1 | <1 | <1 |
| Inv. Ex. 1 | <0.2 | <0.3 | <0.4 |

TABLE 3
mustard gas

| | Penetration | Penetration | Penetration |
|---|---|---|---|
| | 0-6 h | 6-24 h | 0-24 h |
| | (μg/cm²) | (mg · min/m³) | (mg · min/m³) |
| Comparison | 11.9 | 29.4 | 41.3 |
| Inv. Ex. 1 | 1.8 | 2.1 | 3.9 |
| Inv. Ex. 1 | 0.2 | 0.3 | 0.5 |

The tests show that the protective performance against liquid noxiants/toxics can be significantly enhanced by providing a wrap of the aforementioned type, in that the protective performance of the wrap can be further enhanced by endowing it with an additional oleophobic and hydrophobic finish.

1. A functional protective clothing unit (1) providing protective performance against chemical and/or biological toxics and noxiants, more particularly warfare agents, wherein the protective clothing unit (1) includes a protective suit (2) equipped with at least one adsorption material to adsorb organic substances and providing protective performance against chemical and/or biological toxics and noxiants, more particularly warfare agents, and a wrap (3) assigned to the protective suit (2) and rejecting organic substances in liquid form, wherein to extend the protective performance provided by the protective suit (2) the wrap (3) in the donned state is disposed over the protective suit (2) and covers the protective suit (2) at least partially and/or regionally.

2. The protective clothing unit according to claim 1 wherein the wrap (3) in the donned state covers at least the trunk of a wearer.

3. The protective clothing unit according to claim 1 or 2 wherein the wrap (3) includes a head opening and/or wherein the wrap (3) includes arm openings and/or leg openings.

4. The protective clothing unit according to any preceding claim wherein the wrap (3) includes arm elements and/or leg elements.

5. The protective clothing unit according to any preceding claim wherein the wrap (3) includes a collar and/or wherein the wrap (3) includes a hood (4), more particularly wherein the hood (4) is equipped with receiving and/or connecting elements for an NBC protective mask (5).

6. The protective clothing unit according to any preceding claim wherein the wrap (3) is formed as a cape, as a cloak, as a poncho, as an apron, as a cowl, as a vest, as a jacket, as a coat or the like, preferably as a poncho.

7. The protective clothing unit according to any preceding claim wherein the wrap (3) includes or consists of, preferably consists of, a textile sheet material, more particularly wherein the textile sheet material is formed as a woven, knitted, laid or bonded fabric, more particularly as a fibrous nonwoven web, preferably as a woven fabric.

8. The protective clothing unit according to claim 7 wherein the woven fabric is formed as a ripstop, twill or plain construction.

9. The protective clothing unit according to any preceding claim wherein the wrap (3) and/or the sheet material comprises or consists of, preferably consists of, manufactured fibers and/or yarns, preferably synthetic fibers and/or yarns, more particularly selected from the group consisting of polyesters (PES), polyolefins, more particularly polyethylene (PE) and/or polypropylene (PP), polyvinyl chloride (CLF), polyvinylidene chloride (CLF), acetate (CA), triacetate (CTA), acrylic (PAN), polyamide (PA), more particularly aromatic, preferably flame-retardant polyamides, fluoropolymers, more particularly polytetrafluoroethylene (PTFE), polyvinyl alcohol (PVAL), polyurethanes, polyvinyl esters, (meth)acrylates, and mixtures thereof, preferably polyamide (PA) and/or polyester (PES).

10. The protective clothing unit according to any preceding claim wherein the wrap (3) and/or the textile sheet material has a basis weight of 20 to 150 g/m², more particularly 25 to 125 g/m², preferably 30 to 100 g/m² and more preferably 40 to 70 g/m².

11. The protective clothing unit according to any preceding claim wherein the wrap (3) and/or the textile sheet material has a thickness of 0.02 to 2 mm, more particularly 0.04 to 1 mm, preferably 0.06 to 0.5 mm, more preferably 0.08 to 0.25 mm and even more preferably 0.09 to 0.12 mm.

12. The protective clothing unit according to any preceding claim wherein the wrap (3) includes a finish which prevents or at least retards the passage of organics in liquid form.

13. The protective clothing unit according to any preceding claim wherein the wrap (3) includes an oleophobic and/or hydrophobic finish.

14. The protective clothing unit according to claim 12 or 13 wherein the wrap (3) is provided with the finish at least on that side which in the donned state faces the organics in liquid form, and/or wherein the wrap (3) is provided with the finish at least on that side which faces away from the protective suit (2).

15. The protective clothing unit according to any one of claims 12 to 14 wherein the finish is present in the form of an impregnation or coating, more particularly by means of at least one fluorocarbon and/or at least one hydrofluorocarbon, more particularly a fluorinated polymer.

16. The protective clothing unit according to any one of claims 12 to 14 wherein the finish is applied by plasma treatment.

17. The protective clothing unit according to claim 16 wherein the plasma treatment is carried out directly on the surface(s) of the wrap (3), or wherein the plasma treatment is carried out indirectly on the surface(s) of the wrap (3), more particularly after application of a preferably polymeric or polymerizable film onto the surface(s) to be treated, which is crosslinked and/or cured by the plasma treatment, more particularly wherein silicones, more particularly silicone oils, or organopolysiloxanes can be used as polymeric or polymerizable film.

18. The protective clothing unit according to any preceding claim wherein the wrap (3) is gas permeable, more particularly air permeable, more particularly wherein the gas or air transmission rate of the wrap (3) is 10 to 200 1·m⁻²·s⁻¹, more particularly at least 20 1·m⁻²·s⁻¹, preferably at least 40 1·m⁻²·s⁻¹, more preferably at least 60 1·m⁻²·s⁻¹, and/or up to 1000 1·m⁻²·s⁻¹ at a flow resistance of 127 Pa, and/or wherein the wrap (3) is gas impermeable, more particularly air impermeable.

19. The protective clothing unit according to any one of claims 1 to 18 wherein the wrap (3) in the donned state lies loose and/or unconnectedly on the protective suit (2).

20. The protective clothing unit according to any one of claims 1 to 18 wherein the wrap (3) in the donned state is more particularly sectionally connectable to the protective suit (2), more particularly wherein the connection is effected by means of hook and loop fasteners, zip fasteners, press studs, buttons, straps, buckles, ribbons, rubber bands or the like.

21. The protective clothing unit according to any preceding claim wherein the wrap (3) is foldable particularly for stocking and/or storage and/or transportation purposes, more particularly wherein the wrap (3) is introducible into a package.

22. The protective clothing unit according to any preceding claim wherein the wrap (3) is attachable, accommodatable and/or securable to or in the protective suit (2) more particularly in the folded state and/or in a packaged form more particularly for stocking and/or storage and/or transportation purposes.

23. The protective clothing unit according to any preceding claim wherein the protective suit (2) is one pieced, more particularly in the form of an overall, or multipieced, more particularly two pieced, preferably in the form of a jacket or a pant.

24. The protective clothing unit according to any preceding claim wherein the adsorption material is activated carbon and/or wherein the protective suit (2) includes an adsorption layer with the noxiant-adsorbing adsorption material, more particularly in the form of activated carbon.

25. The protective clothing unit according to claim 24 wherein the adsorption layer is discontinuous, and/or wherein the adsorption layer is formed as an adsorption sheet filter.

26. The protective clothing unit according to claim 24 or 25 wherein the adsorption material is secured to a carrier layer, more particularly a textile carrier layer, more particularly wherein the adsorption material is disposed on that side which in the donned state faces away from the carrier layer and/or the carrier side facing in the direction of the wrap (3).

27. The protective clothing unit according to any one of claims 24 to 26 wherein the adsorption material of the adsorption layer is a material based on activated carbon in the form of activated carbon particles and/or activated carbon fibers.

28. The protective clothing unit according to any one of claims 24 to 27 wherein the adsorption layer by way of adsorption material comprises discrete activated carbon particles, preferably in granule form (“granulocarbon”) or sphere form (“spherocarbon”), more particularly wherein the average diameter of the activated carbon particles is less than 1.0 mm, preferably less than 0.8 mm and more preferably less than 0.6 mm, and/or more particularly wherein the activated carbon particles are present in the adsorption layer in an amount of 5 to 500 g/m², more particularly 10 to 400 g/m², preferably 20 to 300 g/m² and more preferably 25 to 250 g/m².

29. The protective clothing unit according to any one of claims 24 to 28 wherein the adsorption layer by way of adsorption material comprises activated carbon fibers, more particularly in the form of an activated carbon sheet body, more particularly wherein the activated carbon sheet body has a basis weight of 20 to 200 g/m² and more particularly 50 to 150 g/m², and/or more particularly wherein the activated carbon sheet body is a woven, loop-formingly knitted, laid or bonded activated carbon fabric, more particularly based on carbonized and activated cellulose and/or a carbonized and activated acrylonitrile.

30. The protective clothing unit according to any preceding claim wherein the adsorption material, more particularly the activated carbon, has an internal surface area (BET) of at least 800 m²/g, more particularly of at least 900 m²/g, preferably of at least 1000 m²/g and more preferably in the range from 800 to 2500 m²/g.

31. The protective clothing unit according to any preceding claim wherein the protective suit (2) has a multilayered construction, wherein the layered construction comprises an outer layer, which in the donned state faces away from the wearer and/or toward the wrap (3), and an inner layer, assigned to the outer layer and in the donned state facing toward the wearer and/or away from the wrap (3), wherein between the outer layer and the inner layer there is disposed an adsorption layer with the noxiant-adsorbing adsorption material, more particularly activated carbon, more particularly as defined in claims 23 to 29.

32. The protective clothing unit according to any preceding claim wherein the protective suit (2) additionally includes at least one membrane, more particularly wherein the membrane is water impermeable and/or air impermeable, and/or more particularly wherein the membrane is breathable, more particularly water vapor permeable.

33. The protective clothing unit according to claim 31 or 32 wherein the membrane is disposed between the outer layer and the adsorption layer and/or between the inner layer and the adsorption layer, preferably between the outer layer and the adsorption layer, and/or wherein the membrane is at least essentially impermeable to chemical and/or biological toxics and noxiants, more particularly warfare agents, or at least retards their passage.

34. The protective clothing unit according to any preceding claim wherein the protective clothing unit (1) includes at least one additional wrap (3) in the form of leggings, gaiters and/or overboots (6) and/or in the form of oversleeves and/or overgloves (7).

35. The use of a wrap rejecting organic substances in liquid form to extend the protective performance against chemical and/or biological toxics and noxiants, more particularly warfare agents, of a protective suit equipped with at least one adsorption material to adsorb organic substances, wherein the wrap is donned over the protective suit to obtain a protective clothing unit wherein the wrap covers the protective suit at least partially and/or regionally.

36. The use according to claim 35 wherein a wrap according to any one of claims 1 to 22 and/or a protective suit according to any one of claims 1 and/or 23 to 33 is/are used.

37. A wrap (3) with properties rejecting organic substances in liquid form, preferably in the form of a poncho, wherein the wrap (3) includes or consists of a textile sheet material, preferably in the form of a woven fabric and/or preferably of manufactured fibers, wherein the textile sheet material has a basis weight of 20 to 150 g/m² and/or a thickness of 0.02 to 2 mm, and wherein the wrap (3) includes a finish preventing or at least retarding the passage of organics in liquid form.

38. The wrap according to claim 37 characterized by one or more of the features of claims 1 to 22.
